(19) United States
(12) Patent Application Publication
(10) Pub. No.: US 2025/0262125 A1
(43) Pub. Date: Aug. 21, 2025

(54) METHOD OF MANUFACTURING BEFORE-USE DISSOLUTION INFUSION BAG

(71) Applicant: FUJIFILM Corporation, Tokyo (JP)

(72) Inventor: Yoshiki SAKAZAKI, Minamiashigara-shi (JP)

(73) Assignee: FUJIFILM Corporation, Tokyo (JP)

(21) Appl. No.: 19/199,617

(22) Filed: May 6, 2025

Related U.S. Application Data
(63) Continuation of application No. PCT/JP2023/042108, filed on Nov. 24, 2023.

(30) Foreign Application Priority Data
Dec. 26, 2022 (JP) 2022-207987

(51) Int. Cl. A61J 1/10; A61J 1/20

(52) U.S. Cl. CPC A61J 1/10; A61J 1/2024; A61J 1/2093

(57) ABSTRACT

Provided is a method of manufacturing a before-use dissolution infusion bag in which a pressing strength required for dissolution before use can be maintained to be low. A method of manufacturing a before-use dissolution infusion bag, includes: a sterilization step of sterilizing an infusion bag including two chambers for accommodating drugs and a weak sealed portion for isolating the two chambers from each other such that the two chambers are communicable with each other; a pinhole forming step of providing two pinholes in a strong sealed portion for isolating the chambers of the infusion bag and an outside from each other after the sterilization step; a positioning step of positioning the infusion bag and a cover sheet having pinholes such that the same pins are inserted into the pinholes formed in the infusion bag and the pinholes of the cover sheet, respectively, and the cover sheet covers an outer surface of one chamber among the two chambers; and a welding step of pressing a pressing member to weld the infusion bag and the cover sheet in a state where the infusion bag and the cover sheet are positioned, in which a straight line formed by connecting centers of the two pinholes formed in the infusion bag is positioned on the weak sealed portion.

### CROSS-REFERENCE TO RELATED APPLICATIONS

This application is a Continuation of PCT International Application No. PCT/JP2023/042108 filed on Nov. 24, 2023, which claims priority under 35 U.S.C. § 119(a) to Japanese Patent Application No. 2022-207987 filed on Dec. 26, 2022. The above applications are hereby expressly incorporated by reference, in their entirety, into the present application.

### BACKGROUND OF THE INVENTION

### 1. Field of the Invention

The present invention relates to a method of manufacturing a before-use dissolution infusion bag.

### 2. Description of the Related Art

A before-use dissolution infusion bag that is used in a medical setting or the like, includes a plurality of chambers, and is partitioned by a communicable partition member is known. In the before-use dissolution infusion bag, for example, a drug having hygroscopicity (for example, an antibiotic) and a liquid drug such as a dissolving solution are accommodated in different chambers, and by pressing one chamber before use, the drug and the liquid drug are mixed through the partition member that partitions these chambers.

Typically, the before-use dissolution infusion bag is formed of a resin film having low gas barrier properties. In a case where the drug having hygroscopicity (for example, an antibiotic) is accommodated in the chamber of the before-use dissolution infusion bag, the drug or the like may absorb moisture such that the quality is changed. Therefore, a cover sheet having gas barrier properties is bonded to an outer surface of the chamber for accommodating the drug or the like of the before-use dissolution infusion bag to use the drug.

For example, JP1992-364851A (JP-H04-364851A) describes a multi-chamber container having flexibility where a plurality of chambers for accommodating a liquid drug, a powdered drug, or a solid medicine are partitioned by a communicable partition unit, the multi-chamber container including: a water-impermeable and/or gas-impermeable outer wall that covers the entirety of one chamber among the plurality of chambers; and a water-permeable and/or gas-permeable inner wall that configures a chamber covered with the outer wall, in which a space portion between the inner wall and the outer wall is encapsulated with a desiccant and/or an oxygen scavenger, and the chamber in the inner wall is encapsulated with a liquid drug, a powdered drug, or a solid medicine having easy oxidability and/or hygroscopicity.

### SUMMARY OF THE INVENTION

This multi-chamber container (before-use dissolution infusion bag) is formed by sterilizing a resin bag consisting of a resin film, encapsulating the resin bag with a drug, and welding and bonding a film having barrier properties to the resin bag.

As described above, in a case where the before-use dissolution infusion bag is used, by pressing one chamber, a chamber for accommodating a drug or the like having hygroscopicity and a chamber for accommodating a liquid drug such as a dissolving solution communicate with each other such that the drug and the liquid drug are mixed with each other (are dissolved before use). Therefore, the partition member that partitions the two chambers is bonded with a lower bonding strength than a bonding strength of peripheral ends of the resin bag.

Here, according to an investigation by the present inventors, it was found that, in order to reduce a pressing strength required for communication of the partition member that partitions the chamber for accommodating the drug or the like and the chamber for accommodating the liquid drug, the cover sheet needs to be bonded to the partition member (weak scaled portion) with high positional accuracy. In order to bond the cover sheet to the partition member with high accuracy, it is considered to provide a pinhole for positioning in each of the resin bag and the cover sheet such that, by allowing a pin to pass through the pinholes, the resin bag (partition member) and the cover sheet are positioned with high accuracy.

However, the resin bag includes a strong sealed portion that bonds the peripheral ends with a high bonding strength and a weak sealed portion (partition member) that is bonded with a weaker bonding strength than the strong sealed portion. Therefore, a form deformed by thermal contraction and/or thermal expansion due to heat or the like during sterilization cannot be expected. Therefore, it was found that, in a case where the pinhole for positioning is formed before sterilization, the shape and/or size of the pinhole is deformed and the accuracy cannot be ensured.

In addition, the entire resin bag is bent due to heat during sterilization. In addition, unpredictable deformation such as curling may be present in the cover sheet, and thus it is difficult to accurately fix the cover sheet on a plane.

Therefore, it was found that, simply even with the configuration of providing a pinhole for positioning in each of the resin bag and the cover sheet such that, by allowing a pin to pass through the pinholes, the resin bag (partition member) and the cover sheet are positioned with high accuracy, it is difficult to position the cover sheet relative to the partition member (weak sealed portion) with high positional accuracy.

As a result, it was found that there is a problem in that a pressing strength required for communication (dissolution before use) of the partition member (weak sealed portion) that partitions the chamber for accommodating the drug or the like and the chamber for accommodating the liquid drug increases.

An object of the present invention is to solve the above-described problem of the related art and to provide a method of manufacturing a before-use dissolution infusion bag in which a pressing strength required for dissolution before use can be maintained to be low.

In order to achieve the object, the present invention has the following configurations.
[1] A method of manufacturing a before-use dissolution infusion bag, the method comprising:
   a sterilization step of sterilizing an infusion bag including two chambers for accommodating drugs and a weak sealed portion for isolating the two chambers from each other such that the two chambers are communicable with each other;
   a pinhole forming step of providing two pinholes in a strong sealed portion for isolating the chambers of the infusion bag and an outside from each other after the sterilization step;
   a positioning step of positioning the infusion bag and a cover sheet having pinholes such that the same pins are inserted into the pinholes formed in the infusion bag and the pinholes of the cover sheet, respectively, and the cover sheet covers an outer surface of one chamber among the two chambers; and
   a welding step of pressing a pressing member to weld the infusion bag and the cover sheet in a state where the infusion bag and the cover sheet are positioned,
   in which a straight line formed by connecting centers of the two pinholes formed in the infusion bag is positioned on the weak sealed portion.
[2] The method of manufacturing a before-use dissolution infusion bag according to [1],
   in which in the welding step, an entire area of a welded portion surrounding the one chamber is simultaneously welded.
[3] The method of manufacturing a before-use dissolution infusion bag according to [1],
   in which in the welding step, the infusion bag and the cover sheet are sequentially welded from a side of the two pinholes.
[4] The method of manufacturing a before-use dissolution infusion bag according to [3],
   in which in the welding step, the infusion bag and the cover sheet are sequentially welded from the side of the two pinholes using the pressing member having a curved surface.
[5] The method of manufacturing a before-use dissolution infusion bag according to [3],
   in which in the welding step, the infusion bag and the cover sheet are sequentially welded from the side of the two pinholes using the pressing member that is divided for each of blocks.

According to the present invention, it is possible to provide a method of manufacturing a before-use dissolution infusion bag in which a pressing strength required for dissolution before use can be maintained to be low.

### BRIEF DESCRIPTION OF THE DRAWINGS

FIG. 1 is a cross sectional view conceptually showing an example of a before-use dissolution infusion bag prepared using a method of manufacturing a before-use dissolution infusion bag according to the present invention.

FIG. 2 is a plan view showing the before-use dissolution infusion bag shown in FIG. 1.

FIG. 3 is a conceptual diagram showing an example of the method of manufacturing a before-use dissolution infusion bag according to the present invention.

FIG. 4 is a conceptual diagram showing the example of the method of manufacturing a before-use dissolution infusion bag according to the present invention.

FIG. 5 is a conceptual diagram showing the example of the method of manufacturing a before-use dissolution infusion bag according to the present invention.

FIG. 6 is a conceptual diagram showing the example of the method of manufacturing a before-use dissolution infusion bag according to the present invention.

FIG. 7 is a conceptual diagram showing the example of the method of manufacturing a before-use dissolution infusion bag according to the present invention.

FIG. 8 is a conceptual diagram showing the example of the method of manufacturing a before-use dissolution infusion bag according to the present invention.

FIG. 9 is a conceptual diagram showing another example of the method of manufacturing a before-use dissolution infusion bag according to the present invention.

FIG. 10 is a conceptual diagram showing another example of the method of manufacturing a before-use dissolution infusion bag according to the present invention.

FIG. 11 is a diagram showing an action of dissolution before use in the before-use dissolution infusion bag.

FIG. 12 is a diagram showing a relationship of a positional relationship between a weak sealed portion and a cover sheet with a required pressing strength.

FIG. 13 is a diagram showing a relationship of a positional relationship between a weak sealed portion and a cover sheet with a required pressing strength.

### DESCRIPTION OF THE PREFERRED EMBODIMENTS

Hereinafter, a method of manufacturing a before-use dissolution infusion bag according to an embodiment of the present invention will be described in detail based on preferred examples shown in the accompanying drawings.

In the present invention, numerical ranges represented by “to” include numerical values before and after “to” as lower limit values and upper limit values.

### Before-Use Dissolution Infusion Bag

First, a configuration of a before-use dissolution infusion bag prepared using the method of manufacturing a before-use dissolution infusion bag according to the embodiment of the present invention will be described.

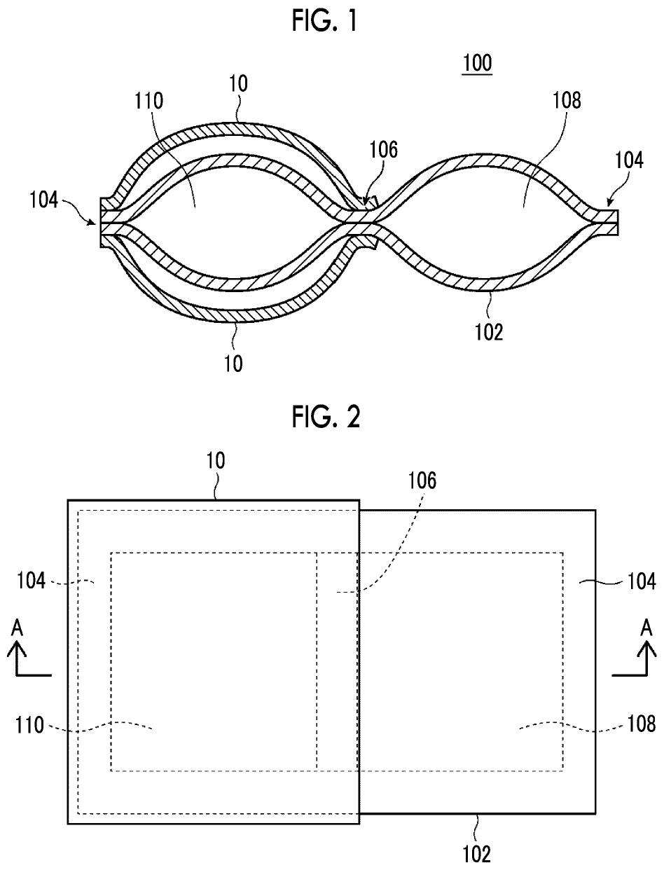

FIG. 1 conceptually shows an example of the before-use dissolution infusion bag prepared using the method of manufacturing a before-use dissolution infusion bag according to the embodiment of the present invention. FIG. 2 is a top view showing the before-use dissolution infusion bag of FIG. 1. FIG. 1 is a cross sectional view taken along a line A-A in FIG. 2.

A before-use dissolution infusion bag 100 shown in FIGS. 1 and 2 includes a resin bag (bag body) 102 and two cover sheets 10.

In the before-use dissolution infusion bag 100, the resin bag 102 and the cover sheet 10 are bonded to each other by thermal welding (heat sealing) through a sealant layer. In addition, in the example shown in the drawing, peripheral portions of the resin bag 102 and the cover sheets 10 are bonded to form a space therebetween.

### Resin Bag

As shown in FIGS. 1 and 2, the resin bag 102 is a bag where peripheral ends of two resin films are joined through a strong sealed portion 104 or a bag where one resin film is folded and peripheral ends are joined through the strong sealed portion 104. The strong sealed portion 104 through which the peripheral ends of the resin films are joined is a sealed portion for isolating a chamber of the resin bag 102 and the outside from each other.

In addition, as shown in FIGS. 1 and 2, the resin bag (bag body) 102 includes two chambers 108 and 110, and the two chambers are partitioned by a weak sealed portion (partition member) 106. In addition, the weak sealed portion 106 is a sealed portion having a weaker bonding strength than the strong sealed portion 104 where the peripheral ends of the resin films are joined. In the example shown in FIG. 2, all of the peripheral ends of the two resin films substantially having a rectangular shape are joined through the strong sealed portion 104 to form an inner space. In FIG. 2, the inner space is separated into the two chambers 108 and 110 by the weak sealed portion 106 extending from the strong sealed portion 104 on an upper end side to the strong sealed portion 104 on a lower end side.

Examples of a material of the resin bag 102 (resin film) include a resin film such as a polyethylene resin or a polypropylene resin. In addition, in the case of the bag where two resin films are joined, the two resin films may be films consisting of different materials and are preferably films consisting of the same material. In a case where the films consisting of the same material are bonded to each other using a heat sealing method, the films can be easily bonded to each other.

The thickness of the resin film of the resin bag 102 is preferably 20 to 200 μm.

The strong sealed portion 104 and the weak sealed portion 106 can be formed using a heat sealing method.

In addition, a method of forming the weak sealed portion 106 is not particularly limited as long as the weak sealed portion 106 has a weaker bonding strength than the strong sealed portion 104. By changing conditions (a temperature, a pressing strength, and the like) during heat sealing during the formation of the strong sealed portion 104, the weak sealed portion 106 having a weaker bonding strength may be formed. By heat-sealing the two resin films with different kinds of resin layers interposed therebetween at a position where the weak sealed portion 106 is formed, the weak sealed portion 106 may have a weaker bonding strength than the strong sealed portion 104. By scattering the strong sealed portions having a small area that can be fractured in an airtightly closed region, the weak sealed portion 106 having a sea-island structure that exhibits the same weak sealing function in a macro manner may be formed.

The bonding strengths of the strong sealed portion 104 and the weak sealed portion 106 may be adjusted to be in well-known ranges in the related art. As described in JIS Z 0238:1998, the bonding strength of the strong sealed portion 104 is preferably 23 N/15 mm or more, and the bonding strength of the weak sealed portion 106 is preferably 3 N/15 mm or less.

In the resin bag 102, typically, peripheral ends (end parts) of the resin film other than a necessary outlet (for example, a liquid discharge port of an infusion bag) may be completely joined.

The kind of the resin bag (bag body) 102 is preferably used for packaging a product that requires gas barrier properties. Examples of the product to be packaged include food, non-food, and chemical. The state of the product to be packaged may be liquid, solid, or powdered. It is preferable that, by appropriately performing heat sealing, the packaging material is bag-shaped. Specific examples of the packaging material include a packaging bag for food, a packaging bag for chemical, and an infusion bag.

### Infusion Bag

In a case where the resin bag 102 is an infusion bag, for example, one chamber 108 accommodates a liquid drug such as a dissolving solution, and the other chamber 110 accommodates a drug having hygroscopicity (for example, an antibiotic). In this case, the cover sheet 10 is bonded to an outer side surface of the chamber 110 for accommodating a drug having hygroscopicity.

In the infusion bag, the weak sealed portion 106 is peeled off immediately before use, the liquid drug and the drug are mixed, and the mixture is infused from the liquid discharge port.

Examples of the drug used in the infusion bag include liquid to be administered under the skin or into the blood vessel or abdominal cavity by drip infusion or the like. In the case of the duplex bag, examples of the drug include powdered drug and liquid such as saline. Examples of the powder drug include a nutrient such as vitamin or amino acid, an antibiotic, and an antibacterial agent.

In addition, within a range not departing from the scope of the present invention, techniques described in JP2003-230618A and JP1998-201818A (JP-H10-201818A) can be considered.

### Cover Sheet

The cover sheet 10 is a film-shaped member having gas barrier properties. The cover sheet 10 is bonded to at least one of the outer side surfaces of the chamber 110 for accommodating the drug or the like having hygroscopicity in the resin bag 102, that is, the surfaces of the resin film opposite to the chamber 110. In addition, as shown in FIG. 1, it is preferable that a peripheral end of the cover sheet 10 is bonded to the resin film. As a result, the drug or the like having hygroscopicity can be prevented from absorbing moisture, and the quality can be prevented from being changed.

As the cover sheet 10, a well-known cover sheet that can be used for a before-use dissolution infusion bag in the related art can be appropriately used.

Examples of the cover sheet 10 include a metal foil such as aluminum foil, a laminated film where a metal layer such as aluminum is formed on a resin film, and a gas barrier film such as silicon nitride or silicon oxide where an inorganic layer and an organic layer are laminated described in JP2015-171798A, JP2014-024602A, and the like.

In addition, in a case where the two cover sheets 10 are bonded to both of the outer side surfaces of the chamber 110 of the resin bag 102, respectively, the two cover sheets 10 may be the same kind of films or may be different kinds of films. From the viewpoint that the inside of the chamber 110 is visible, one cover sheet 10 is preferably a gas barrier film where an inorganic layer and an organic layer are laminated.

The sealant layer (thermal welding layer) is bonded to the cover sheet 10, and the cover sheet 10 is bonded to the resin bag 102 by heat sealing (thermal welding (thermal fusion)).

### Sealant Layer

The sealant layer is a layer for bonding the cover sheet 10 to an object by heat sealing (thermal welding (thermal fusion)).

Basically, the sealant layer is formed of the same forming material as the object to which the cover sheet is heat-sealed. For example, in a case where the object is an infusion bag, the sealant layer is formed of the same material as the material for forming the infusion bag. That is, in a case where the object to be heat-sealed is formed of polyethylene (PE), a sheet-shaped material (film-shaped material) formed of PE may be used as the sealant layer, and in a case where the object to be heat-sealed is formed of polypropylene (PP), a sheet-shaped material (film-shaped material) formed of PP may be used as the sealant layer.

Specifically, as the material for forming the sealant layer, a resin film described in paragraph [0015] of JP2012-075716A can be used.

In addition, the thickness of the sealant layer is not also limited, and may be appropriately selected depending on the material for forming the sealant layer and the shape, state, or the like of the object such as an infusion bag to be heat-sealed such that the object can be reliably thermally welded. Here, according to the study by the present inventors, the thickness of the sealant layer is preferably 5 to 150 μm, more preferably 10 to 100 μm, and still more preferably 30 to 70 μm. The thickness of the sealant layer is preferably 5 μm or more from the viewpoints that, for example, more reliable heat sealing can be performed and unevenness of a surface of the object to be heat-sealed can be suitably absorbed. The thickness of the sealant layer is preferably 150 μm or less from the viewpoints that, for example, the thickness of the before-use dissolution infusion bag can be reduced and permeation of water vapor and/or oxygen from a side surface of the sealant layer during thermal welding of the infusion bag or the like can be more effectively suppressed.

### Adhesive Layer

An adhesive layer is a layer for bonding the sealant layer and the cover sheet 10.

As the adhesive layer, all of well-known adhesives through which the sealant layer can adhere to the cover sheet 10 can be used.

In addition, the thickness of the adhesive layer is not limited, and may be appropriately selected such that the sealant layer can reliably adhere to the cover sheet 10.

### Method of Manufacturing Before-Use Dissolution Infusion Bag

A method of manufacturing a before-use dissolution infusion bag according to the embodiment of the present invention, comprises:
a sterilization step of sterilizing an infusion bag including two chambers for accommodating drugs and a weak sealed portion for isolating the two chambers from each other such that the two chambers are communicable with each other;
a pinhole forming step of providing two pinholes in a strong sealed portion for isolating the chambers of the infusion bag and an outside from each other after the sterilization step;
a positioning step of positioning the infusion bag and a cover sheet having pinholes such that the same pins are inserted into the pinholes formed in the infusion bag and the pinholes of the cover sheet, respectively, and the cover sheet covers an outer surface of one chamber among the two chambers; and
a welding step of pressing a pressing member to weld the infusion bag and the cover sheet in a state where the infusion bag and the cover sheet are positioned,
in which a straight line formed by connecting centers of the two pinholes formed in the infusion bag is positioned on the weak sealed portion.

The method of manufacturing a before-use dissolution infusion bag according to the embodiment of the present invention (hereinafter, also referred to as the manufacturing method according to the embodiment of the present invention) will be sequentially described.

The manufacturing method according to the embodiment of the present invention includes the welding step of bonding (thermally welding) the cover sheet 10 after the sterilization step of sterilizing the above-described resin bag (bag body, infusion bag) 102, forms the pinholes in the resin bag 102 (pinhole forming step) before the welding step and after the sterilization step, positions the cover sheet 10 using the pinholes (positioning step), and positions the straight line formed by connecting the centers of the pinholes on the weak sealed portion.

### Sterilization Step

The sterilization step is a step of performing a well-known sterilization method in the related art, for example, sterilization by high-pressure steam, sterilization by hydrogen peroxide gas, electron beam sterilization, or gamma sterilization in the manufacturing of the before-use dissolution infusion bag.

In general, in the manufacturing of the before-use dissolution infusion bag, after disposing the two resin films to form the weak sealed portion 106, the strong sealed portion 104 other than a region where a portion for charging the drug is formed is formed. Next, after providing a port on the chamber 108 side for accommodating the drug or further filling the chamber 108 with the chemical liquid and closing the port, the sterilization step is performed.

### Pinhole Forming Step

The pinhole forming step is a step of providing two pinholes in the strong sealed portion for isolating the chambers of the resin bag 102 and the outside from each other after the sterilization step.

The pinhole forming step is performed between the sterilization step and the welding step.

In general, after the sterilization step, the drug is put into the chamber 110 that is opened, the opening is sealed and closed (strongly sealed), and the resin bag 102 and the cover sheet are welded (welding step). Accordingly, after the sterilization step, the pinhole forming step may be performed before putting the drug into the chamber 110 and closing and sealing the opening. Alternatively, the pinhole forming step may be performed after putting the drug into the chamber 110 and closing and sealing the opening.

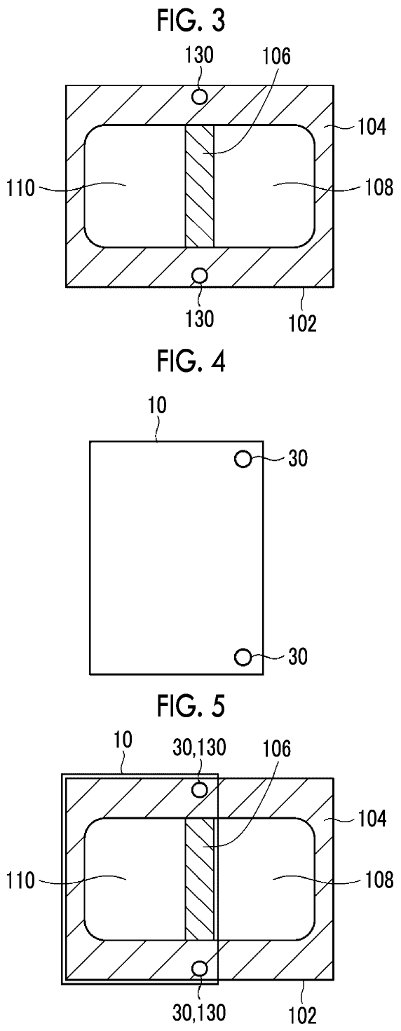

Here, in the pinhole forming step, as shown in FIG. 3, the pinholes are formed such that a straight line formed by connecting the centers of the two pinholes 30 is positioned on the weak sealed portion 106. That is, the pin hole is formed in the vicinity of each of both ends of the weak sealed portion 106 in a longitudinal direction. In this case, the position of the pinhole 30 may be set with reference to a marker printed on the resin bag 102, may be set with reference to the strong sealed portion 104 or the weak sealed portion 106, or may be set with reference to an end side of the resin bag 102. It is preferable that the positions of the two pinholes 30 are preferably set with reference to the end side of the weak sealed portion 106 on the chamber 108 side. For example, it is preferable that the positions are set such that a straight line formed by connecting the centers of the two pinholes 30 is substantially parallel to the end side of the weak sealed portion 106 on the chamber 108 side at a predetermined distance. The straight line formed by connecting the centers of the two pinholes 30 may be non-parallel to the end side of the weak sealed portion 106 on the chamber 108 side.

In FIGS. 3 and 5, the shape of an invisible portion of the object is also indicated by a solid line.

A method of forming the pinholes 30 in the pinhole forming step is not particularly limited, and a well-known processing method such as punching or laser processing may be used.

In addition, the size and shape of the pinholes 30 are not limited as long as the pin can be inserted into the pinholes 30, and are preferably the same as a cross sectional shape of the pin. The shape of the pinholes 30 is preferably circular. In addition, the circle-equivalent diameter of the pinholes 30 may be appropriately set depending on the stiffness of the resin film, and is preferably 5 mm to 15 mm.

In addition, the distance between the two pinholes 30 may be appropriately set depending on the shape of the resin bag 102 and the like.

### Positioning Step

The positioning step is performed after the pinhole forming step and is a step of positioning the resin bag 102 and the cover sheet 10 having two pinholes 130 shown in FIG. 4 such that the same pins are inserted into the pinholes 30 formed in the resin bag 102 and the pinholes 130 of the cover sheet 10, respectively, and the cover sheet 10 covers an outer surface of one chamber 108 among the two chambers.

The cover sheet 10 has a size where one chamber 110 of the resin bag 102 can be covered, in which the two pinholes 130 are formed. In the example shown in FIG. 4, the cover sheet 10 has a substantially rectangular shape where the pinhole 130 is formed on both end parts (an upper end part and a lower end part in FIG. 4) in the vicinity of one side (the right end side in FIG. 4).

A method of forming the pinholes 130 in the cover sheet 10, the shape and size thereof, the distance between the pinholes, and the like are the same as those of the pinholes 30 formed in the resin bag 102.

It is preferable that the positions of the pinholes 130 on the cover sheet 10 are set with reference to the end side of the cover sheet 10 on the chamber 108 side during welding to the resin bag 102. For example, it is preferable that the positions are set such that a straight line formed by connecting the centers of the two pinholes 130 is substantially parallel to the end side of the cover sheet 10 on the chamber 108 side at a predetermined distance. The straight line formed by connecting the centers of the two pinholes 130 may be non-parallel to the end side of the cover sheet 10 on the chamber 108 side.

In the positioning step, as shown in FIG. 5, by inserting the same pins into the two pinholes 30 formed in the resin bag 102 and the two pinholes 130 of the cover sheet 10, respectively, the resin bag 102 and the cover sheet 10 are positioned.

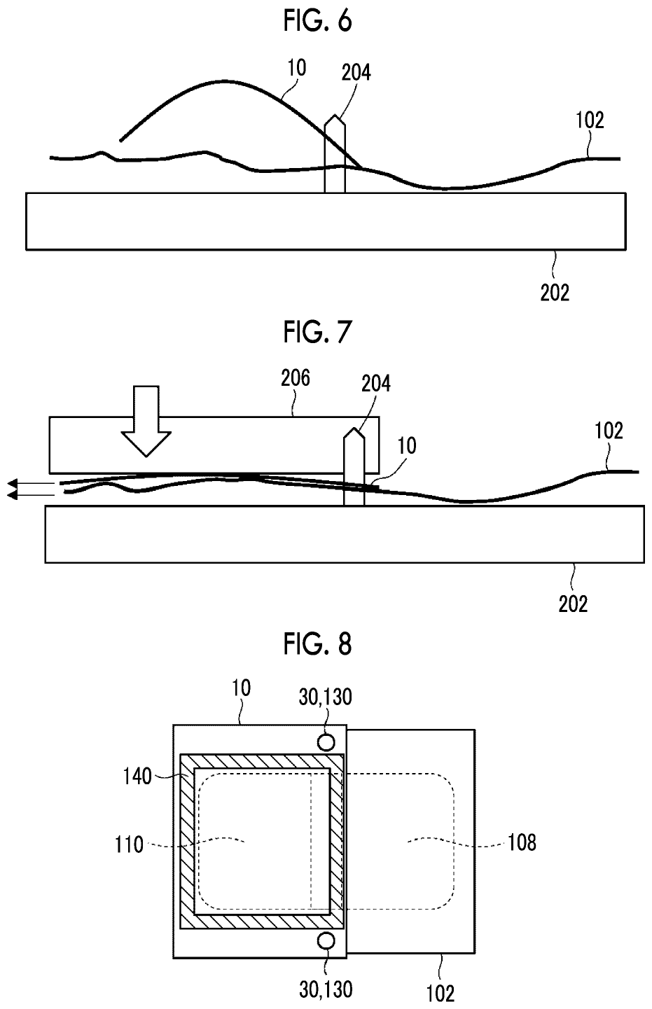

For example, as shown in FIG. 6, the resin bag 102 is placed on a placement table 202 where two pins 204 stand while inserting the pins 204 into the two pinholes 30, respectively, and the cover sheet 10 is placed while inserting the pins 204 into the two pinholes 130, respectively. As a result, the cover sheet 10 can be appropriately positioned relative to the resin bag 102.

In addition, the position of the end side of the cover sheet 10 can be more accurately positioned relative to the weak sealed portion 106 of the resin bag 102. As a result, a pressing strength required for communication (dissolution before use) of the weak sealed portion 106 that partitions the chamber 110 for accommodating the drug or the like and the chamber 108 for accommodating the liquid drug can be prevented from increasing. This point will be described below.

As shown in FIG. 6, the cover sheet 10 may be curled. In this case, it is preferable that the pinholes 30 are formed such that a straight line formed by connecting the two pinholes 30 is substantially parallel to an axial direction of the curling.

### Welding Step

The welding step is performed after the positioning step and is a step of pressing a pressing member to weld the resin bag 102 and the cover sheet 10 in a state where the resin bag 102 and the cover sheet 10 are positioned.

As shown in FIG. 7, the resin bag 102 and the cover sheet 10 placed on the placement table 202 by inserting the pins 204 into the pinholes are pressed from the cover sheet 10 side by a pressing member 206 to weld the resin bag 102 and the cover sheet 10. As in a region indicated by a diagonal line in FIG. 8, a welded portion 140 where the resin bag 102 and the cover sheet 10 are welded is formed at a position where the strong sealed portion 104 and the weak sealed portion 106 around the chamber 110 overlap each other to cover the chamber 110. In the example shown in FIG. 8, the welded portion 140 is formed in a substantially rectangular shape along the end side of the cover sheet 10. That is, the welded portion 140 is formed in the vicinity of four respective end parts of the rectangular cover sheet 10.

Accordingly, the pressing member 206 includes a frame-shaped pressing unit corresponding to the welded portion 140. In addition, the pressing member 206 includes a heating member that heats the frame-shaped pressing unit, and can thermally weld (heat-seal) the resin bag 102 and the cover sheet 10.

In the example shown in FIG. 7, the pressing member 206 simultaneously welds the entire area of the welded portion 140, that is, the four sides of the cover sheet 10.

In the present invention, a welding method in the welding step is not limited to the method of simultaneously welding the entire area of the welded portion 140, and the welded portion 140 may be sequentially welded. For example, the welding method may be the method of sequentially welding the welded portion 140 in a direction away from the side of the two pinholes.

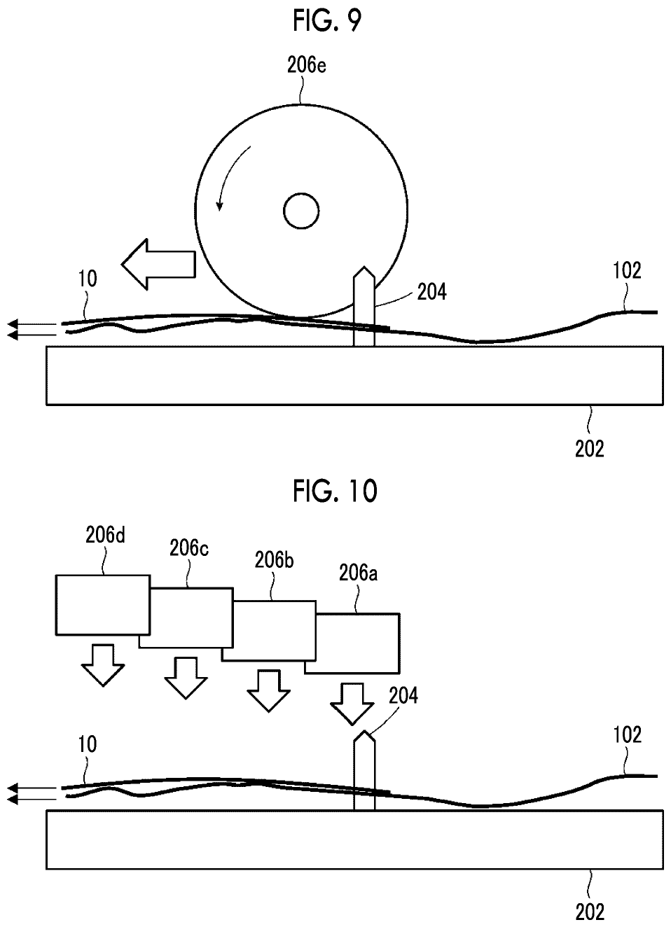

For example, as in the example shown in FIG. 9, while pressing the resin bag 102 and the cover sheet 10 using a pressing member 206e such as a roller having a curved surface, the pressing member 206e may be moved in the direction away from the position on the pin 204 side to sequentially weld the region where the welded portion 140 is formed. In this case, a portion of the pressing member 206e that comes into contact with the chamber 110 is formed in a recessed shape, and presses only the region where the welded portion 140 is formed.

Alternatively, the pressing member may be divided into a block shape corresponding to a partial region of the welded portion 140, and may sequentially weld the resin bag 102 and the cover sheet 10 from the pin 204 side using the divided pressing member.

For example, in the example shown in FIG. 10, the pressing member is divided into four pressing members 206a to 206d. The resin bag 102 and the cover sheet 10 are welded using the pressing member 206a on the pin 204 side. Next, the resin bag 102 and the cover sheet 10 are welded using the pressing member 206b adjacent to the pressing member 206a. Next, the resin bag 102 and the cover sheet 10 are welded using the pressing member 206c adjacent to the pressing member 206b. Next, the resin bag 102 and the cover sheet 10 are welded using the pressing member 206d adjacent to the pressing member 206c. As a result, the region where the welded portion 140 is formed is sequentially welded.

A heating temperature during the welding in the welding step may be appropriately set depending on the kind of the sealant layer, the required bonding strength, the material and thickness of the cover sheet, and the like.

A pressing strength during the welding in the welding step may be appropriately set depending on the kind of the sealant layer, the required bonding strength, the material and thickness of the cover sheet, and the like.

Through the above-described steps, the before-use dissolution infusion bag is prepared.

Here, according to an investigation by the present inventors, it was found that, in order to reduce a pressing strength required for communication of the weak sealed portion (partition member) that partitions the chamber for accommodating the drug or the like and the chamber for accommodating the liquid drug, the cover sheet needs to be bonded to the weak sealed portion with high positional accuracy.

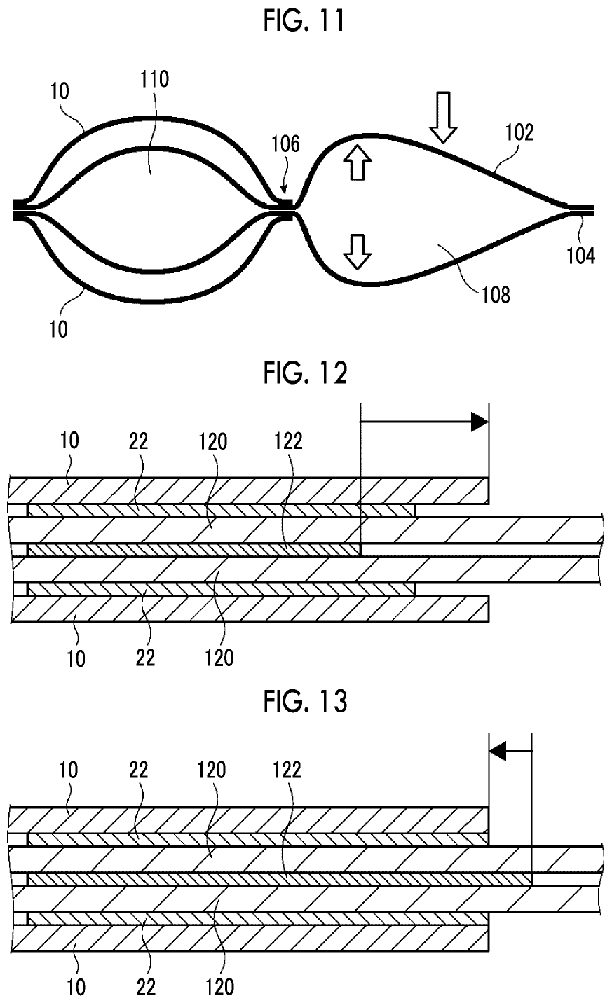

Specifically, during the communication (dissolution before use) of the weak sealed portion 106 that partitions the chamber 110 for accommodating the drug or the like and the chamber 108 for accommodating the liquid drug, as shown in FIG. 11, the chamber 108 for accommodating the liquid drug is pressed, the vicinity of the weak sealed portion 106 in the chamber 108 is swelled out and the resin film in the vicinity of the weak sealed portion 106 is pulled in the vertical direction in the drawing such that the weak sealed portion 106 is peeled off and the chambers communicate with each other.

In this case, it was found that, in a case where the end side of the cover sheet 10 on the chamber 108 side is present closer to the chamber 108 side than the end side of the weak sealed portion 106 on the chamber 108 side, a required pressing strength for the dissolution before use can be reduced.

This point will be described using FIGS. 12 and 13.

Each of FIGS. 12 and 13 is a partially enlarged view showing the vicinity of the weak sealed portion 106 of the before-use dissolution infusion bag. In FIGS. 12 and 13, the right side in the drawing is the chamber 108, and the left side is the chamber 110. As shown in FIGS. 12 and 13, in the weak sealed portion 106, the cover sheet 10, the sealant layer 22, a resin film 120, a sealing layer 122, the resin film 120, the sealant layer 22, and the cover sheet 10 are laminated in this order.

As shown in FIG. 13, in a case where the end side of the cover sheet 10 on the chamber 108 side is present closer to the chamber 110 side than the end side of the weak sealed portion 106 on the chamber 108 side, first, a portion where the resin films 120 are weakly scaled is peeled off. Next, a portion where the laminates of the cover sheet 10, the sealant layer 22, and the resin film 120 are weakly sealed is peeled off. However, the laminate of the cover sheet 10, the sealant layer 22, and the resin film 120 is harder than the resin film 120 and is not likely to be deformed. Therefore, a strength for deforming the laminate during the peeling is required, and a required pressing strength increases.

On the other hand, as shown in FIG. 12, in a case where the end side of the cover sheet 10 on the chamber 108 side is present closer to the chamber 110 side than the end side of the weak scaled portion 106 on the chamber 108 side, first, the laminate of the cover sheet 10, the sealant layer 22, and the resin film 120 is pulled in the vertical direction to be deformed, and the portion where the laminates are weakly sealed is peeled off. A strength for propagation of the deformation of the cover sheet 10 is lower than a strength for starting the deformation of the cover sheet 10. Therefore, a required pressing strength can be reduced.

Accordingly, in order to reduce a pressing strength required for dissolution before use, it is important to appropriately dispose relative positions between the end side of the cover sheet 10 on the chamber 108 side and the end side of the weak sealed portion 106 on the chamber 108 side.

In order to bond the cover sheet 10 to the weak sealed portion 106 with high accuracy, it is considered to provide a pinhole for positioning in each of the resin bag 102 and the cover sheet 10 such that, by allowing a pin to pass through the pinholes, the resin bag 102 (weak sealed portion 106) and the cover sheet 10 are positioned with high accuracy.

However, the resin bag 102 includes a strong scaled portion 104 that bonds the peripheral ends with a high bonding strength and a weak sealed portion 106 that is bonded with a weaker bonding strength than the strong sealed portion 104. Therefore, a form deformed by thermal contraction and/or thermal expansion due to heat or the like during sterilization cannot be expected. Therefore, it was found that in a case where the pinhole 130 for positioning is formed before sterilization, the shape and/or size of the pinhole 130 is deformed and the accuracy cannot be ensured.

In addition, the entire resin bag 102 is bent due to heat during sterilization. In addition, unpredictable deformation such as curling may be present in the cover sheet 10, and thus it is difficult to accurately fix the cover sheet 10 on a plane.

Therefore, it was found that, simply even with the configuration of providing a pinhole for positioning in each of the resin bag 102 and the cover sheet 10 such that, by allowing a pin 204 to pass through the pinholes, the resin bag 102 (weak sealed portion 106) and the cover sheet 10 are positioned with high accuracy, it is difficult to position the cover sheet 10 relative to the weak sealed portion 106 with high positional accuracy.

As a result, it was found that there is a problem in that a pressing strength required for communication (dissolution before use) of the weak sealed portion 106 that partitions the chamber 110 for accommodating the drug or the like and the chamber 108 for accommodating the liquid drug increases.

On the other hand, in the manufacturing method according to the embodiment of the present invention, the pinhole forming step of providing the pinhole 130 in the resin bag 102 is performed after the sterilization step, and the two pinholes 130 formed in the pinhole forming step are formed such that a straight line formed by connecting the centers of the two pinholes 130 is positioned on the weak sealed portion 106. As a result, the shape and/or size of the pinhole 130 can be prevented from being deformed, the pinhole 130 can be positioned relative to the resin bag 102 deformed due to heat during sterilization with high accuracy. In addition, since the pinhole 130 is formed in the vicinity of the weak sealed portion 106, the pinhole 130 can be positioned relative to the end side of the weak sealed portion 106 on the chamber 108 side with high accuracy. Accordingly, in a case where the cover sheet 10 is welded, a positional relationship between the end side of the cover sheet 10 on the chamber 108 side and the end side of the weak sealed portion 106 on the chamber 108 side can be determined with high accuracy. Therefore, as shown in FIG. 12, the configuration where the end side of the cover sheet 10 on the chamber 108 side is present closer to the chamber 110 side than the end side of the weak sealed portion 106 on the chamber 108 side can be reliably formed. Accordingly, a before-use dissolution infusion bag having a low pressing strength required for dissolution before use can be prepared.

In the manufacturing method according to the embodiment of the present invention, in a case where the two cover sheets 10 are welded to the resin bag 102, at least one of the cover sheets 10 may be welded to the resin bag 102 using the manufacturing method, and it is preferable that both of the two cover sheets 10 are welded to the resin bag 102 using the manufacturing method. In addition, in a case where the two cover sheets 10 are welded to the resin bag 102 using the manufacturing method, the positioning step and the welding step may be performed on each of the two cover sheets 10 to sequentially weld each of the two cover sheets 10, or the positioning step and the welding step may be simultaneously performed on the two cover sheets 10 to simultaneously weld the two cover sheets 10.

Hereinbefore, the method of manufacturing a before-use dissolution infusion bag according to the embodiment of the present invention has been described in detail. However, the present invention is not limited to the above-described aspects and various improvements and changes may be made within a range not departing from the scope of the present invention.

### Explanation of References

10: cover sheet
22: sealant layer
30: pinhole
100: before-use dissolution infusion bag
102: resin bag (bag body, infusion bag)
104: strong sealed portion
106: weak sealed portion
108, 110: chamber
120: resin film
122: sealing layer
130: pinhole
140: welded portion
202: placement table
204: pin
206, 206a to 206e: pressing member

What is claimed is:

1. A method of manufacturing a before-use dissolution infusion bag, the method comprising:
a sterilization step of sterilizing an infusion bag including two chambers for accommodating drugs and a weak sealed portion for isolating the two chambers from each other such that the two chambers are communicable with each other;
a pinhole forming step of providing two pinholes in a strong sealed portion for isolating the chambers of the infusion bag and an outside from each other after the sterilization step;
a positioning step of positioning the infusion bag and a cover sheet having pinholes such that the same pins are inserted into the pinholes formed in the infusion bag and the pinholes of the cover sheet, respectively, and the cover sheet covers an outer surface of one chamber among the two chambers; and
a welding step of pressing a pressing member to weld the infusion bag and the cover sheet in a state where the infusion bag and the cover sheet are positioned,
wherein a straight line formed by connecting centers of the two pinholes formed in the infusion bag is positioned on the weak sealed portion.

2. The method of manufacturing a before-use dissolution infusion bag according to claim 1,
wherein in the welding step, an entire area of a welded portion surrounding the one chamber is simultaneously welded.

3. The method of manufacturing a before-use dissolution infusion bag according to claim 1,
wherein in the welding step, the infusion bag and the cover sheet are sequentially welded from a side of the two pinholes.

4. The method of manufacturing a before-use dissolution infusion bag according to claim 3,
wherein in the welding step, the infusion bag and the cover sheet are sequentially welded from the side of the two pinholes using the pressing member having a curved surface.

5. The method of manufacturing a before-use dissolution infusion bag according to claim 3,
wherein in the welding step, the infusion bag and the cover sheet are sequentially welded from the side of the two pinholes using the pressing member that is divided for each of blocks.
